(19) United States
(12) Patent Application Publication
(10) Pub. No.: US 2011/0175727 A1
(43) Pub. Date: Jul. 21, 2011

(54) APPARATUS AND METHOD FOR SELF-CONTAINED INSPECTION OF SHIPPING CONTAINERS

(76) Inventor: ANTONIOS AIKATERINIDIS, Baltimore, MD (US)

(21) Appl. No.: 12/265,219

(22) Filed: Nov. 5, 2008

Related U.S. Application Data
(60) Provisional application No. 60/986,411, filed on Nov. 8, 2007.
(60) Provisional application No. 61/041,960, filed on Apr. 3, 2008.

(51) Int. Cl. G08B 21/00

(52) U.S. Cl. 340/540

(57) ABSTRACT

Provided herein are new apparatuses and related methods for an automated global shipping container inspection system for inspecting a shipping container during transportation at a shipping container handling facility including at least one detection device located within the shipping container and in communication with a computer communications network comprising electronic communication means for receiving from the detection device at least one comparison data set selected from the group consisting of an initial data set, a destination data set, and one or more interim data sets. The apparatus provides means responsive to the at least one comparison data set for determining an inspection fail status for the shipping container, such as when at least one comparison data set substantially mismatches another comparison data set for the same shipping container. The apparatus further provides means responsive to the receipt of the inspection fail status to indicate the need for further inspection of the shipping container.

This application claims priority to co-pending U.S. provisional patent application Nos. 60/986,411 filed Nov. 8, 2007 and 61/041,960 filed Apr. 3, 2008, the entire contents of which are incorporated herein by reference.

### INTRODUCTION

This application describes apparatuses and related methods for inspection of closed, self-contained shipping containers for the purpose of detecting, inter alia, contraband or tampering with or disturbance of a shipping container's contents.

### BACKGROUND

The number of shipping containers, either used by rail, truck, or sea-going vessel is steadily increasing each year. Enhanced container inspection technologies to maintain port of entry throughput as volume increases are urgently needed for national security and the protection of world commerce. For reasons of economy and manpower, containers should not be delayed or opened unless a high degree of certainty exists that the container and its contents must be removed for inspection from the flow of goods.

There has long been a recognition that the world's countries are at risk of the delivery of deleterious and hazardous materials, including chemical weapons, nuclear weapons, and biological weapons, to their ports and borders by those seeking to cause harm to a particular country by hiding such materials in shipping containers, including those containers commonly carried by ships, trains, and trucks. Various technologies have been employed to inspect these containers at a particular country's ports or borders.

The widespread use of intermodal shipping containers in international trade presents significant problems with regard to preventing the movement across international borders of various forms of contraband in these containers. Such contraband could range from the relatively innocuous, such as otherwise legal goods improperly described in order to evade customs duties, to explosives and weapons, including weapons of mass destruction, capable of wreaking nuclear, radiological, chemical, or biological havoc.

If the problems of fatigue and inattention generated by repetitive work are addressed, full manual inspection (opening, emptying, examining, re-stowing, and resealing) of every container moving through a particular port or terminal could be effective. However, the demands it places on inspection resources as well as its disruptive effect on commerce severely limit the number of such inspections that can be performed.

Presently, port inspectors are beginning to use newly developed X-ray and gamma ray imagers to see into containers. Typically, X-ray imagers require a radiation source transmitting device to be located on one side of a container and a radiation detection device located on the other side of the container. This requires the removal of personnel from the vehicle while scanning the container. These devices are generally quite large and bulky and a container must be passed between these devices to be scanned. Due to the slowness inherent in using these imagers, port inspectors can not inspect each and every container that comes into a port, so they must rely on conventional screening aides such as trained dogs, profiling, and random selection, to help choose which containers to image.

The current screening units are either permanent stations or mobile units that are placed strategically within close proximity to the vessels during an unloading operation. A major drawback to these units is their expense in cost and the resulting delay in the unloading process. It is not unusual for as many as four cranes to be used to unload one vessel. Depending on the number of cranes being used, it is possible to unload approximately 350 containers per hour from a standard 7,500 twenty-foot equivalent units (“TEU”) container vessel and do a complete turn around of the vessel in 10-12 hours. However, current technology in the X-ray units allows the units to screen a maximum of 90 units per hour, and similar delays occur with sniffing units, which require a long time to acquire a sample of sufficient size to identify dangerous cargo. This can result in extensive delays for units awaiting screening and greatly impedes the movement of units going to storage areas or leaving the terminal.

In the United States, the Maritime Transportation Security Act of 2002, in conjunction with the Container Security Initiative of 2002, requires that containerized cargo entering United States ports be screened for potentially dangerous cargo as related to explosive and nuclear devices. Currently over 9.6 million maritime containers arrive at over 300 United States seaports annually, yet often only a small portion of these containers are screened for content. As a result of these initiatives, several different technologies have been developed to allow for screening the cargo using various types of X-ray or chemical sniffing devices. While several variations are available, no one unit has proven to be all encompassing and provide a complete solution to the inspection process. Current screening units provide X-ray images or chemical analyses, and not actual pictures of the container's cargo, which can provide a more accurate assessment and identification of dangerous contents. Moreover, no current screening unit internally assays a container in a manner that provides reliable content data yet prevents dirt and debris from entering the container. Accordingly, a continuing and unmet need exists for new and improved apparatuses and related methods for inspection of closed, self-contained shipping containers for the purpose of detecting, inter alia, tampering with or disturbance of the contents thereof.

### SUMMARY

Provided herein are new apparatuses and related methods for an automated global shipping container inspection system for inspecting a shipping container during transportation at a shipping container handling facility including at least one detection device located within the shipping container and in communication with a computer communications network comprising electronic communication means for receiving at least one comparison data set selected from the group consisting of an initial data set, a destination data set, and one or more interim data sets; means responsive to the at least one comparison data set for determining an inspection fail status for the shipping container when at least one comparison data set substantially mismatches another comparison data set for the same shipping container; and means responsive to the receipt of the inspection fail status to indicate the need for further inspection of the shipping container.

Also provided herein are new apparatuses and related methods for inspection of closed, self-contained shipping containers for the purpose of detecting, inter alia, contraband or tampering with or disturbance of a container's contents. In an example embodiment, the inspection process assays (inspects, measures, assesses, quantifies, gauges or otherwise detects) containers during any phase of transportation such as off-loading, on-loading, or transport, e.g., at the point of origin, during transport, or at one or more destinations, thereby assuring that every container is fully inspected without delay or disruption to the operation. According to such a process, each container may have an assigned serial number (or other unique indicia) to facilitate the tracking of a container from its point of origin to its final destination.

For example, a shipping container may be fitted with a portable IFIR/infrared camera or other detection device that will scan, record and/or take a photograph of the contents of the shipping container and/or the interior of the shipping container at the time of loading. The resulting data set (i.e., picture) represents cargo configuration, contents, and can detect any motion within the container. This data may be entered into a central database. At the point of arrival, as the container is being off-loaded, another data set may be generated for the arrival contents and compared to the data set taken at the point of origin. Changes in the data set, such as changes in the configuration of the cargo as well as motion of any contents within the container indicate that the container should be opened for additional inspection.

Furthermore, each container may be fitted with two or more motion detection cameras or other measuring or detection devices. For example, detection devices may comprise, e.g., sniffers, X-ray detectors, and radiation detectors, and any other detection device that represents and preserves data concerning the content, including any movement within the container. Based on the actual detection devices selected, data sets such as still photographs or videos are generated to represent the contents of the container during various transportation points. The detector information is recorded and optionally transmitted, e.g., via satellite to a central data bank, where the original information gathered during the loading process at the point of origin can be compared with data collected at any other transportation point. Furthermore, additional means may be provided for scanning or inspecting a container at a point of origin, thereby assuring that the container is fully inspected. Each container may be assigned a unique serial number that provides identification from the point of origin to a port of arrival and that may be used to track the container and its contents, shipping information, and the like.

Additional features may be understood by referring to the accompanying drawings, which should be read in conjunction with the following detailed description and examples.

### DESCRIPTION OF THE DRAWINGS

FIG. 1 schematically illustrates an example shipping container that includes two internal detection devices in accordance with an example embodiment hereof.

FIG. 2 schematically illustrates an example shipping container that includes two internal detection devices during the cargo loading process.

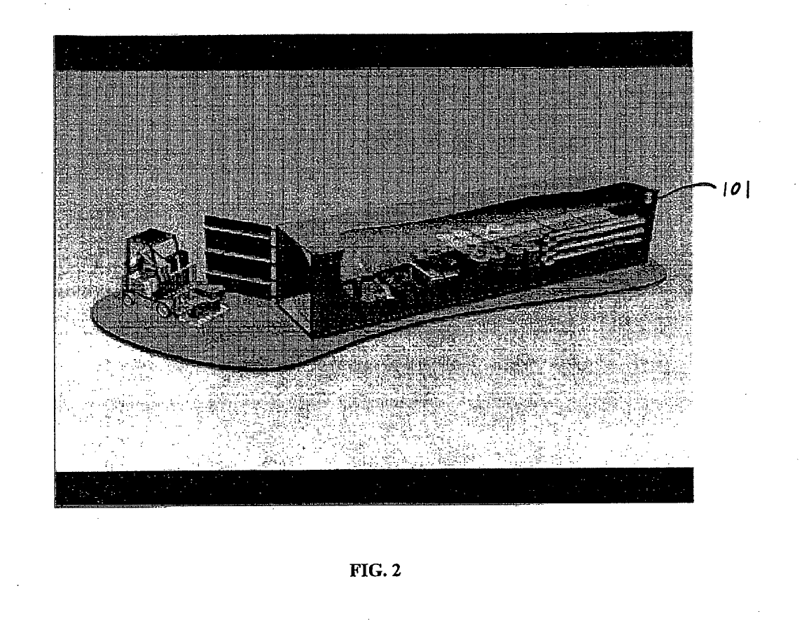

FIG. 3 schematically illustrates an example shipping container that includes two internal detection devices after the conclusion of cargo loading process.

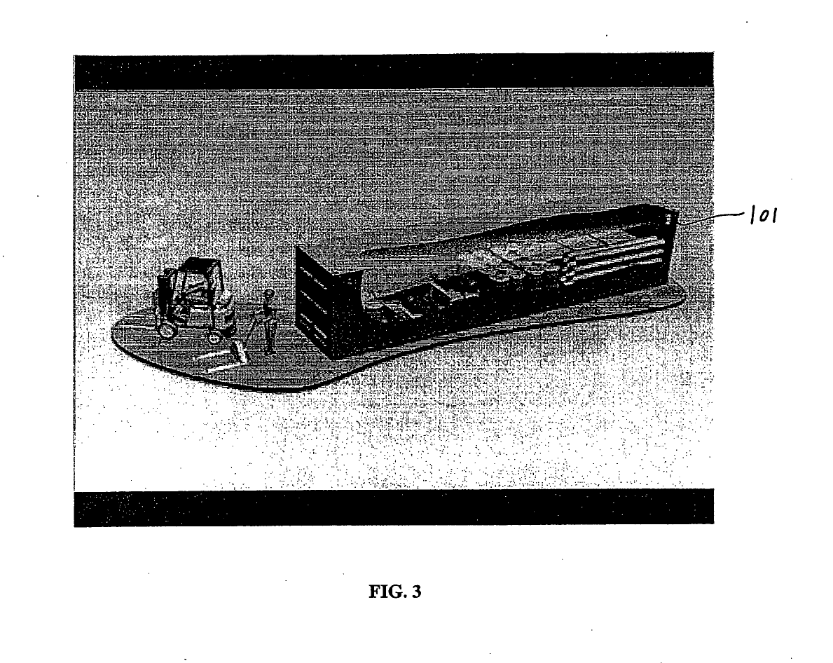

### DETAILED DESCRIPTION AND EXAMPLE EMBODIMENTS

Provided herein are new apparatuses and related methods for an automated global shipping container inspection system for inspecting a shipping container during transportation at a shipping container handling facility including at least one detection device located within the shipping container and in communication with a computer communications network comprising electronic communication means for receiving at least one comparison data set selected from the group consisting of an initial data set, a destination data set, and one or more interim data sets; means responsive to the at least one comparison data set for determining an inspection fail status for the shipping container when at least one comparison data set substantially mismatches another comparison data set for the same shipping container; and means responsive to the receipt of the inspection fail status to indicate the need for further inspection of the shipping container.

The “electronic communication means” include any transfer of signs, signals, writing, images, sounds, data, or intelligence of any nature transmitted in whole or in part by a wire, radio, electromagnetic, photoelectronic or photooptical system. The “means responsive to the at least one comparison data set” and the “means responsive to the receipt of the inspection fail status” may be any automatic (e.g., machine or computer executed), manual, or human process, device, system, or machine (including machine-executable computer code) that provides a response signal that can be acted upon in accordance with the methods described here. A typical “means responsive to the at least one comparison data set” includes a set of computer-executable code that determines whether a significant mismatch between any two or more data sets warrants further inspection. Likewise, a typical “means responsive to the receipt of the inspection fail status” includes human-readable signal or instruction that indicates that a particular shipping container should be subjected to additional (e.g., manual) inspection.

The apparatus includes at least one detection device. Each detection device may be an imaging probe, such as a camera (e.g., a CCD camera), an infrared camera, an ultrasonic imager, a sonic imager, or any other type of imaging probe. Likewise, the detection device may include a chemical sampler or a sniffer, an X-ray probe, a gamma-ray detector or other radiation detector, a sonic sampler or imager, an ultrasonic probe or imager, or any type of probe or detector that may be employed to measure the content of a shipping container. Measurements may include the spatial distribution, geometric configuration, weight distribution, and/or chemical composition of the container and its contents. When a camera is used as a detection device, it may be desirable to illuminate the contents of a shipping container, and therefore one or more light sources may optionally also be mounted within a shipping container.

A shipping container, as used herein, includes intermodal freight transport shipping containers. Such containers can be loaded and sealed intact onto container ships, railroad cars, planes, and trucks. However, the principles described herein may be employed in the inspection of other similar types of containers. There are several common standard lengths of shipping containers: 20 ft. (6.1 m), 40 ft. (12.2 m), 45 ft. (13.7 m), 48 ft. (14.6 m), and 53 ft (16.2 m). In the United States, domestic standard shipping containers are generally 48 ft. and 53 ft. (rail and truck). Container capacity is often expressed in twenty-foot equivalent units (“TEU”); an equivalent unit is a measure of containerized cargo capacity equal to one standard 20 ft. (length)×8 ft. (width) container. A shipping container is typically constructed of rigid metal sidewalls, a metal top, and a metal bottom, where at least one of the end walls forms a door into the interior of the shipping container. However, any material can be used to form the shipping container contemplated in the present invention.

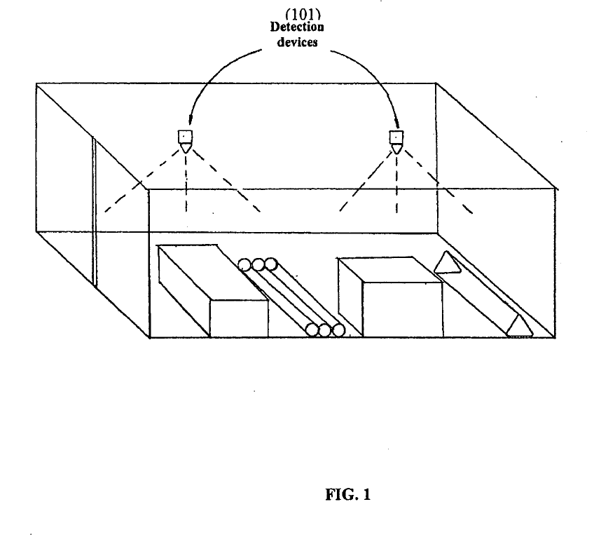

Referring to the example depicted in FIG. 1, two detection devices are shown (101), in this example as imaging probes. The imaging probes are disposed for capturing images of contents of the shipping container and relaying those images to an operator or a machine for examination. The detection devices may each be a standard digital camera, an infrared camera, an ultrasonic imager, a sonar imager, or the like, or any combination thereof. The container may comprise one, two or more detection devices. The detection devices may optionally include a light, laser, or LED for illuminating the inside and contents of the container. The detection devices may be optimally configured external to the container so long as the internal contents can be monitored.

The use of an imaging probe as a detection device provides clear advantages over previous systems. An imaging probe can identify structures or mechanisms present in the cargo, which might be used to contain or conceal chemical traces. Also, an imaging probe can zoom in on suspicious areas, providing additional information when desired. However, the detection devices need not necessarily be a camera, and may be or include various other imaging probes such as the following non-limiting examples: an X-ray probe, (which can perform an X-ray from within the container with greater resolution and accuracy than an X-ray performed from outside of the container); or an ultrasonic or sonic probe, (which can use sound waves to image the inside or contents of the container). In addition, each detection device is not limited to imaging probes, and may also be a chemical sampler that can identify trace amounts of dangerous chemicals or chemical signatures of dangerous devices or compounds; a sniffer which can identify chemical signatures of explosives; a gamma-ray detector which can identify radiation signatures of nuclear compounds or weapons; or a sonic sampler which can record sounds from within the container for analysis. The detection device can also perform an action on the container contents if necessary, such as creating an electromagnetic pulse or irradiating the contents. Based on the findings of the detection device, the container may be referred for more detailed or other inspection, by way of tagging, rerouting, or any other method of referral.

The use of multiple detection devices allows for the inspection of containers even when the container is reversed, and/or when an obstruction blocks the movement or field-of-view of one detection device. The illustration of two detection devices in FIG. 1 is only provided for ease of explanation, and one detection device or more than two detection devices on the same, opposite, or connecting sides of the container, may be used. The detection devices are shown installed on the top of the shipping container above the cargo because this location is likely to allow a clear unobstructed view of the contents of the shipping container. However, other locations may be selected, including lower corners, central areas, and other desirable locations.

Accordingly, in an embodiment, a method of inspecting a closed, self-contained shipping container includes detecting contents of a shipping container having/utilizing one or more detection devices mounted at one or more fixed locations within the shipping container located therein, to obtain an initial data set detecting the contents of the shipping container using the one or more detection devices to obtain a destination data set; comparing the initial data set with destination data set; and detecting at least one difference between the initial data set and the destination data set to detect tampering and/or disturbance of the contents of the shipping container. For example, the initial data set may be obtained at a point of origin of the shipping container, and the destination data set may be obtained at a destination location of the shipping container.

In still another embodiment, a method of inspecting a closed, self-contained shipping container further includes detecting the contents of the shipping container utilizing the one or more detection devices to obtain one or more interim data sets. For example, the one or more interim data sets may be obtained at intermediate locations of the shipping container during transportation.

In still yet another embodiment, a method of inspecting a closed, self-contained shipping container includes transmitting the initial data set, the destination data set, and/or the one or more interim data sets to a central data location; storing the initial data set, the destination data set, and/or the one or more interim data sets in a database to thereby produce stored data sets; and, comparing (e.g., with an automated computer executed algorithm) at least two of the stored data sets. For example, the transmitting step may occur via satellite linkage, or through the internet, telephone, or other electronic communication means.

In yet another embodiment, the method further includes opening the container for detailed physical (e.g., manual) inspection in the event of motion detection within the container or changes in its cargo configuration as determined by comparing one or more of the initial data set, the destination data set, and the one or more interim data sets.

As described more fully herein, a detection devices record data corresponding to the container's contents or motion thereof within the container during transportation.

Each shipping container may be assigned a unique serial number to provide identification from point of origin to final destination, and to facilitate tracking the container and its contents or other shipping information.

Also provided is an apparatus for inspecting a shipping container. In one embodiment, the apparatus comprises a shipping container having an assigned serial number and one or more detection devices mounted at one or more fixed locations within the shipping container. The one or more detection devices collect data relating to the contents of the shipping container during on-loading, off-loading, or during any transitory phase of the container's transportation from point of origin to a final destination. In an embodiment, the one or more detection devices are selected from the group consisting of motion detection cameras, sniffers, X-ray detectors, and radiation detectors. In another embodiment, two or more detection devices are mounted at fixed locations on the underside of the top of the shipping container. In yet another embodiment, the detectors can be moved and/or rotated to further monitor locations on the container. In still another embodiment, the detectors may be on a moveable track that can be controlled remotely or automatically to monitor from different positions various locations within the container. In still another embodiment, the one or more detection devices comprise a camera that provides a still photograph or video showing the contents of the shipping container, wherein the camera is an IFIR/infrared camera or other known detection device that scans, records, and/or photographs the contents or interior of the container. In yet another embodiment, the apparatus comprises means for detecting and analyzing data gathered at points of origin and at interim and/or final destinations, and means for assuring inspection of a shipping container without unnecessary delay or disruption to the shipping container's transportation. Typical “means for detecting and analyzing data” include a computer executing computer code that compares data sets as described herein. Likewise, typical “means for assuring inspection of a shipping container” may include electronic or paper records that indicate whether a shipping container has passed inspection in accordance with the methods described herein.

The present subject matter also relates to a method of fitting a shipping container for inspection to occur during transfer of the shipping container. The present subject matter further relates to an apparatus for inspecting a shipping container during transfer of the shipping container. The present subject matter also relates to an apparatus for facilitating inspection of a shipping container during transit. Furthermore, the present subject matter relates to an apparatus for inspecting a shipping container during transfer of the shipping container. The present subject matter also relates to a shipping container pre-designed for inspection, the inspection to occur during transfer of the shipping container. The present subject matter further relates to a system for inspecting a shipping container during transfer of the shipping container, the system comprising means for imaging the contents of the shipping container.

Also provided herein is an automated inspection system for the detection of items of interest based upon analysis of a density, shape, mass and/or atomic number of the items within a shipping container. Items of interest represent any item shipped via shipping container that may be desired to be identified, such as explosives, weapons, drugs, cigarettes, alcohol, for example, as well as ordinary article of commerce (e.g., food, furniture, machinery, and the like). In another embodiment, the inspection system detects items of interest based upon an unexpected density variation or gradient, such as to detect drugs, explosives or other contraband within a shipping container. In an embodiment, the inspection system performs an initial, high speed screening to localize areas of the shipping container that may include items of interest, and a second, targeted screening of the localized areas of the shipping container with an appropriate speed to provide the required discrimination of the items of interest. In an embodiment, the shipping origin, as well as any intermediate destinations, may indicate an increased (or decreased) possibility of items of interest within a shipping container. The information regarding the entity responsible for shipping the container may, for example in conjunction with a history of previous inspection results for containers shipped by the same company, be relevant to determine who are expected to have a lesser or greater likelihood of shipping containers including suspect objects. Accordingly, it will be appreciated that the inspection system includes several operation scenarios that can provide various inspection throughputs. The inspection system includes several implementation options, which may include using such pre-inspection information.

The steps of a shipping container inspection method as described herein may be embodied in the form of computer-implemented processes and apparatuses for practicing those processes. They may also be embodied in the form of a computer program product having computer program code containing instructions embodied in tangible media, such as CD-ROMs, hard drives, USB (universal serial bus) drives, or any other computer readable storage medium, wherein, when the computer program code is loaded into and executed by a computer, the computer becomes an apparatus for practicing the method. They also may be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the method. When implemented on a general-purpose microprocessor, the computer program code segments configure the microprocessor to create specific logic circuits. A technical effect of the executable instructions is to increase a throughput of the inspection of shipping containers that may contain items of interest.

Some embodiments of the inspection system provide the following advantages: the ability to detect items of interest within shipping containers; the ability to detect items of interest in the presence of materials intended to shield these items within shipping containers; the ability to identify portions of the container that may require a more thorough inspection; the ability to reduce total inspection time by performing a shipping container pre-scan with the same equipment to be used for a more thorough inspection; and the ability to reduce total inspection time using a low intensity pre-scanning.

While this description is made with reference to exemplary embodiments, it will be understood by those skilled in the art that various changes may be made and equivalents may be substituted for elements thereof without departing from the scope. In addition, many modifications may be made to adapt a particular situation or material to the teachings hereof without departing from the essential scope. Also, in the drawings and the description, there have been disclosed exemplary embodiments and, although specific terms may have been employed, they are unless otherwise stated used in a generic and descriptive sense only and not for purposes of limitation, the scope of the claims therefore not being so limited. Moreover, one skilled in the art will appreciate that certain steps of the methods discussed herein may be sequenced in alternative order or steps may be combined. Therefore, it is intended that the appended claims not be limited to the particular embodiment disclosed herein.

1. An automated shipping container inspection system for inspecting a shipping container including at least one detection device within said shipping container; a computer communications network comprising electronic communication means for receiving at least one comparison data set from the at least one detection device, the data set selected from the group consisting of an initial data set, a destination data set, and optionally one or more interim data sets; means responsive to said at least one comparison data set for determining an inspection fail status for said shipping container (when at least one comparison data set mismatches another comparison data set for the same shipping container); and means responsive to the receipt of said inspection fail status to indicate to a user the need for further inspection of said shipping container.

2. A method of inspecting a closed, self-contained shipping container comprising:
detecting contents of a shipping container with one or more detection devices to obtain an initial data set;
thereafter, detecting said contents of said shipping container using the one or more detection devices to obtain a destination data set,
comparing said initial data set with destination data set; and,
detecting a difference between said initial data set and said destination data set to indicate tampering with and/or disturbance of said contents of said shipping container.

3. The method according to claim 2, wherein said initial data set is obtained at a point of origin of said shipping container, and wherein said destination data set is obtained at a destination location of said shipping container.

4. The method according to claim 2, further comprising:
detecting said contents of said shipping container with said one or more detection devices to obtain one or more interim data sets, wherein said one or more interim data sets are obtained at intermediate locations of said shipping container during transportation.

5. The method according to claim 2, further comprising:
transmitting at least one of said initial data set, said destination data set, or said one or more interim data sets to a central data location;
storing said transmitted initial data set, said destination data set, or said one or more interim data sets in a database to yield stored data sets; and
comparing at least two of said stored data sets.

6. The method according to claim 5, wherein said transmitting step occurs via satellite linkage, or through the internet, telephone, or other electronic communication means.

7. The method according to claim 2, wherein said detection devices record data corresponding to said container's contents or motion thereof within said container during transportation.

8. The method according to claim 2, wherein said container is assigned a unique serial number to thereby provide identification from point of origin to final destination and to facilitate tracking said container and its contents or other shipping information.

9. The method according to claim 4, further comprising:
opening said shipping container for physical inspection if the detected difference indicates tampering with or disturbance of said shipping container, such as in the event of motion detection within said container or changes in its cargo configuration as determined by comparing one or more of said initial data set, said destination data set, and said one or more interim data sets.

10. An apparatus for inspecting a shipping container comprising a shipping container having an assigned serial number and at least one or more detection devices mounted at one or more fixed locations within said shipping container, wherein said one or more detection devices collect data relating to the contents of said shipping container during on-loading, off-loading, or during any transitory phase of said container's transportation from point of origin to a final destination.

11. The apparatus according to claim 10, wherein said one or more detection devices are selected from the group consisting of motion detection cameras, sniffers, X-ray detectors, and radiation detectors.

12. The apparatus according to claim 10, wherein two or more detection devices are mounted at fixed locations on the interior underside of the top of said shipping container.

13. The apparatus according to claim 10, wherein said one or more detection devices comprise a camera that provides a still photograph or video showing the contents of said shipping container, wherein said camera is an IFIR/infrared camera or other detection device that scans, records, and/or photographs the contents and/or interior of said container.

14. The apparatus according to claim 10, wherein said apparatus comprises means for detecting and analyzing data gathered at points of origin and at interim or final destinations, and further comprises means for assuring inspection of a shipping container without unnecessary delay or disruption to said shipping container's transportation.
